(19) United States
(12) Patent Application Publication
(10) Pub. No.: US 2023/0153730 A1
(43) Pub. Date: May 18, 2023

(54) TYPE ESTIMATION APPARATUS, TYPE ESTIMATION METHOD AND PROGRAM

(71) Applicant: NIPPON TELEGRAPH AND TELEPHONE CORPORATION, Tokyo (JP)

(72) Inventors: Ai NAKANE, Tokyo (JP); Tessei KOBAYASHI, Tokyo (JP); Naomi WATANABE, Tokyo (JP); Momoko NAKATANI, Tokyo (JP)

(73) Assignee: NIPPON TELEGRAPH AND TELEPHONE CORPORATION, Tokyo (JP)

(21) Appl. No.: 17/912,491

(22) PCT Filed: Mar. 19, 2020
(86) PCT No.: PCT/JP2020/012356

§ 371 Date: Sep. 17, 2022

(51) Int. Cl. G06Q 10/0637

(52) U.S. Cl. CPC G06Q 10/0637

(57) ABSTRACT

A type estimation device includes an input unit that inputs a response by a user to a predetermined question for estimating a parenting goal type of the user, and a goal type estimation unit that estimates the parenting goal type of the user on the basis of the response. The predetermined question is a question about what kind of person the user wants a child to become in the future or what kind of person the user does not want a child to become in the future.

### TECHNICAL FIELD

The present invention relates to a technique that estimates a user's preferences.

### BACKGROUND ART

Many people who raise children have goals for parenting, such as what kind of person they wish their child to be in the future, and understand that those goals are related to the parenting behavior they choose. It is therefore possible to appropriately provide various types of information pertaining to parenting behavior by understanding individual parenting goals. However, it is difficult for both the person raising a child and a service provider to understand the individual parenting goals.

PTL 1 discloses a technique for estimating a target user's preferences on the basis of the information of other people using interpersonal relationship information. The technique disclosed in PTL 1 makes it possible to estimate preference information without obtaining information pertaining to preferences from the target user.

### CITATION LIST

### Patent Literature

[PTL 1] JP 2013-164792A

### SUMMARY OF THE INVENTION

### Technical Problem

However, it is not necessarily the case that people sharing a close interpersonal relationship will also have similar parenting goals. It is therefore difficult to estimate parenting goals on the basis of the information of other people as described in PTL 1.

Having been conceived in light of the foregoing, an object of the present invention is to provide a technique in which a person raising a child can easily understand a parenting goal.

### Means for Solving the Problem

A technique of the disclosure provides a type estimation device, including:

an input unit that inputs a response by a user to a predetermined question for estimating a parenting goal type of the user; and

a goal type estimation unit that estimates the parenting goal type of the user on the basis of the response,

wherein the predetermined question is a question about what kind of person the user wants a child to become in the future or what kind of person the user does not want a child to become in the future.

### Effects of the Invention

According to the disclosure, a person raising a child can easily understand a parenting goal.

### BRIEF DESCRIPTION OF DRAWINGS

FIG. 1 is a block diagram illustrating a type estimation device according to a first example.

FIG. 2 is a flowchart illustrating operations of the type estimation device according to the first example.

FIG. 3 is a block diagram illustrating an information recommendation device according to a variation on the first example.

FIG. 4 is a diagram illustrating an example of information stored in an information recommendation DB 160 according to a variation on the first example.

FIG. 5 is a flowchart illustrating operations of the information recommendation device according to a variation on the first example.

FIG. 6 is a flowchart illustrating operations of the type estimation device according to a second example.

FIG. 7 is a diagram illustrating an example of information stored in an information recommendation DB 160 according to a variation on the second example.

FIG. 8 is a flowchart illustrating operations of the information recommendation device according to a variation on the second example.

FIG. 9 is a diagram illustrating distance calculation and information selection according to a variation on the second example.

FIG. 10 is a block diagram illustrating a list generation unit according to a third example.

FIG. 11 is a flowchart illustrating the accumulation of responses.

FIG. 12 is a diagram illustrating an example of information stored in a response DB.

FIG. 13 is a flowchart illustrating the generation of an information recommendation DB.

FIG. 14 is a diagram illustrating a search for a relationship between a goal type A and “English conversation”.

FIG. 15 is a diagram illustrating the use of an average value of target type scores.

FIG. 16 is a diagram illustrating an example of the hardware configuration of a device.

FIG. 17 is a diagram illustrating experiment results.

FIG. 18 is a diagram illustrating experiment results.

FIG. 19 is a diagram illustrating experiment results.

FIG. 20 is a diagram illustrating experiment results.

FIG. 21 is a diagram illustrating experiment results.

FIG. 22 is a diagram illustrating experiment results.

FIG. 23 is a diagram illustrating experiment results.

FIG. 24 is a diagram illustrating experiment results.

FIG. 25 is a diagram illustrating experiment results.

FIG. 26 is a diagram illustrating experiment results.

FIG. 27 is a diagram illustrating experiment results.

### DESCRIPTION OF EMBODIMENTS

An embodiment of the present invention (the “present embodiment”) will be described hereinafter with reference to the drawings. The embodiment described hereinafter is merely an example, and the embodiments to which the present invention is applied are not limited to the following embodiment. Although the following descriptions assume that a person who raises a child is primarily a mother, the person who raises the child is not limited to a mother. For example, the person may be a father, a grandparent, a teacher, or another person.

As described above, with the conventional technique, it is difficult for both a person raising a child themselves, and for a service provider, to understand parenting goals, and it is also difficult to provide information pertaining to parenting behavior related to parenting goals. To solve this problem, the inventors of the present invention carried out two types of experiments (Experiment 1 and Experiment 2) using parents currently raising children as subjects, and confirmed that (1) parenting goal types can be classified into a total of five types, and (2) parenting attitudes and behavior, thoughts about lessons they wish their children to take in the future, and the like vary depending on the type of the parenting goals of the parent. Detailed content of the experiment results is given at the end of the “Description of Embodiments” section. The “parenting goal type” may be referred to as a “goal type” hereinafter.

(1) Confirming that parenting goal types can be classified into a total of five types

<Experiment 1>

As indicated in result (1) of Experiment 1, a total of six factors were extracted as components of parenting goals.

As indicated in result (2) of Experiment 1, scores for the six factors for each subject were combined, and parenting goal patterns of the subjects were classified into a total of five types (A) to (B) through cluster analysis.

<Experiment 2>

As indicated in result (1) of Experiment 2, a total of five factors were extracted as parenting goal types. Note that in Experiment 2, the factors of the five types were extracted from the beginning, without going through two steps as in Experiment 1.

Experiment 1 and Experiment 2 used different survey items, and the methods for obtaining the goal types were different as well. Nevertheless, in both experiments, five types of parenting goals which can be associated with each other were successfully classified. It was highly likely that these five types would be extracted regardless of what survey items, classification methods, and so on were used.

(2) Confirming relationships between parenting goal types and parenting behavior (confirming that parenting attitudes and behavior, thoughts about lessons they wish their children to take in the future, and the like vary depending on the type of the parenting goals of the parent)

<Experiment 2>

As indicated in result (2) of Experiment 2, a total of three factors were extracted as components of parenting behavior, and as indicated in result (3) of Experiment 2, the relationship between parenting behavior and parenting goals was analyzed.

<Experiment 1>

As indicated in result (3) of Experiment 1, responses to a survey pertaining to parenting behavior were compared for each type of parenting goal, and the relationships between each type of parenting goal and parenting behavior were confirmed.

In the present embodiment, to solve the above-described problem, based on the above-described experiment results, responses to a plurality of questions associated with five parenting goals are obtained from a person raising a child, which makes it possible to estimate the type of parenting goals of that person. The technique according to the present embodiment makes it possible for a person raising a child or a service provider to easily understand parenting goals.

A first example, a second example, and a third example will be described hereinafter.

### First Example

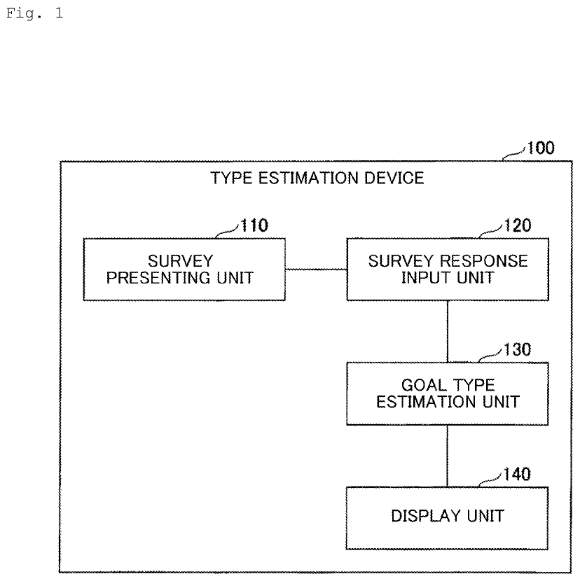

FIG. 1 is a block diagram illustrating a type estimation device 100 according to the first example. As illustrated in FIG. 1, the type estimation device 100 of the first example includes a survey presenting unit 110, a survey response input unit 120, a goal type estimation unit 130, and a display unit 140.

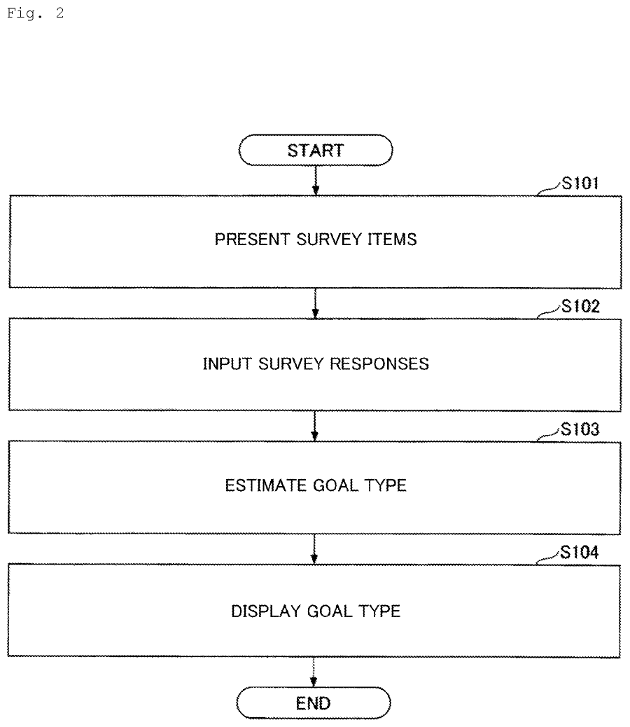

An example of operations of the type estimation device 100 having the above-described configuration will be described according to the order in the flowchart in FIG. 2.

<S101>

In S101, the survey presenting unit 110 presents, to a user, survey items for estimating a parenting goal type. The survey presenting unit 110 is, for example, a display of a PC, but is not limited thereto. The survey item may be presented on paper.

In the survey, for example, a passage reading “Tell us about your parenting style. What do you want your child to be like in the future? Circle the item that most closely matches your opinion” is displayed along with the options “1 disagree—2 slightly agree—3 agree—4 strongly agree—5 very strongly agree” as the survey items.

Examples of the survey items are given below. The following examples also show goal types (one of A to E) to which the items belong. For example, 1 to 10 belong to A.

A: I want them to develop their abilities and become an independent person (goals related to the development of personal abilities)

1. I want them to become able to express themselves in their own way and not settle for the usual

2. I want them to become a person who can dive into anything they want to do without hesitation

3. I want them to become a person who takes on big challenges

4. I want them to become a person who is deeply interested in something particular

5. I want them to become a person who can create (think and create by themselves)

6. I want them to become a person who is competitive in something particular

7. I want them to become a person who follows through with their decisions

8. I want them to become a person who has had a variety of experiences

9. I want them to become a person who can express their opinions openly

10. I want them to become a person who can overcome difficulties on their own

B: I want them to become a person who has a trusting relationship with their parents (goals related to building trusting relationships with parents)

11. I want them to feel reassured that they have a parent (me) they can rely on in times of trouble

12. I want them to think they can rely on their parent (me) in times of trouble

13. I want them to have a loving relationship with their parent (me)

14. I want them to work with me to build a parent-child relationship where they can talk to their parent (me) if something happens

15. I want them to have a sense of trust in their parent (me)

16. I want them to strongly feel they are loved by their parent (me)

17. I want them to feel close to their parent (me)

C: I want them to become a person who can build good relationships with the people around them (goals related to building good relationships with the people around them and society)

18. I want them to become a person loved by everyone

19. I want them to become a person who gets along with everyone

20. I want them to become a person who is accepted by many different people

21. I want them to build many friendships

22. I want them to become a person trusted by everyone

23. I want them to become a person who can communicate well with many different people

24. I want them to become a person who can read situations around them

D: I want them to become a person who is kind to others (goals related to warmth toward others)

25. I want them to become a person who cares about others

26. I want them to become a person who has warm feelings toward others

27. I want them to become a person who can understand another person's position

28. I want them to become a person who cares about their friends

29. I want them to become a person who can always think of others' feelings

30. I want them to become a person who can empathize with others' feelings

31. I want them to become a person who can cooperate with others around them

32. I want them to become a person who can act for others

E: I want them to become a decent member of society (goals related to completeness as a member of society)

33. I don't want them to become a person who lives a lazy life

34. I don't want them to become an apathetic person

35. I don't want them to become a person who leaves things to others and doesn't make any effort on their own

36. I don't want them to become a corrupt person without ambition

37. I don't want them to become a person who doesn't think for themselves

38. I don't want them to become an irresponsible person

39. I want them to become a mature person

40. I want them to become a person with common sense

41. I want them to become a person who can manage their own life

The above-described goal types A to E correspond to Factors 1 to 5 in Experiment 2. Correspondence relationships between Factors 1 to 5 in Experiment 2 and types (A) to (E) in Experiment 1 are as follows.

Factor 1 (I want them to develop their abilities and become an independent person)=Type (A) (type who wants them to build a good life through personal progress)

Factor 2 (I want them to become a person who has a trusting relationship with their parents)=Type (D) (type focused on parent-child relationships)

Factor 3 (I want them to become a person who can build good relationships with the people around them)=Type (C) (type focused on them living well in society)

Factor 4 (I want them to become a person who is kind to others)=Type (B) (type focused on warmth)

Factor 5 (I want them to become a decent member of society)=Type (E) (type who wants them to build a good life by being independent and accepted by society)

Note that the questions for Factor 1 in Experiment 2 (Type (A) in Experiment 1) may be referred to as “questions about improving personal abilities”. The questions for Factor 2 in Experiment 2 (Type (D) in Experiment 1) may be referred to as “questions about the importance of the parent-child relationship”. The questions for Factor 3 in Experiment 2 (Type (C) in Experiment 1) may be referred to as “questions about building good relationships with other companies”. The questions for Factor 4 in Experiment 2 (Type (B) in Experiment 1) may be referred to as “questions about the importance of warmth”. The questions for Factor 5 in Experiment 2 (Type (E) in Experiment 1) may be referred to as “questions about being accepted by society”.

The use of the 41 items described above is merely one example. Additionally, the order in which the items are presented may be randomized for each presentation to each user. For the display format, all items may be listed, or not listed. A plurality of questions may be presented at once, or only one question at a time may be presented.

Each question is an example of a question about what kind of person the parent wants their child to become in the future, or what kind of person the parent does not want their child to become in the future.

When presenting a question in the survey presenting unit 110, five options such as those described above are presented such that the user (the person subject to estimation) can respond by selecting an option. Note that the options do not need to have five levels. Additionally, responses may be selected by moving a slide bar which has “strongly agree” and “strongly disagree” on either side, for example. In this case, a numerical value corresponding to the position where the slider stops, on a continuous variable with 0 to 5 at both ends, is taken as the input value of the response, for example.

<S102>

In S102, the user inputs survey responses through the survey response input unit 120 (e.g., a keyboard or a mouse), and presses a “respond” button displayed in the survey presenting unit 110, for example. Note that a person aside from the user (person subject to estimation) may input responses which have been written on paper.

Having accepted the input of the responses, the survey response input unit 120 transmits, to the goal type estimation unit 130, the survey responses to the respective questions as “survey response numerical value information”.

Note that the numerical value information of the responses to the 41 items may be collectively transmitted to the goal type estimation unit 130 when the “respond” button is pressed, or the numerical value information of one or any number of questions may be transmitted to the goal type estimation unit 130 at one time.

<S103>

In S103, the goal type estimation unit 130 performs goal type estimation according to a predetermined estimation rule on the numerical value information of the responses to the survey, and transmits an estimation result to the display unit 140.

For example, using the above-described example of the 41 questions, the estimation rule calculates an average value of the response values for each of the five goal types, and estimates that the goal type with the highest numerical value among the five average values is the goal type of the person subject to estimation. The stated average values of the response values for each of the five goal types are the average value of the responses to questions 1 to 10, the average value of the responses to questions 11 to 17, the average value of the responses to questions 18 to 24, the average value of the responses to questions 25 to 32, and the average value of the responses to questions 33 to 41. Note that this estimation rule is an example.

In the calculation of the scores for the goal types, the use of average values of the response values described above is one example. Additive values may be used instead of average values. Standardized values using the population mean value and standard deviation that have already been calculated may be used as well. For example, assuming the average value of the response values (target type score) for questions 1 to 10 is 3.2, the population mean is 3, and the population standard deviation is 0.5, a standardized target type score can be calculated as “(target type score−population mean)/population standard deviation=0.4”.

<S104>

In S104, the display unit 140 displays the estimation result obtained in S103. The user can therefore know their own goal type, for example.

(Variation on First Example)

A variation on the first example will be described next. Mainly the differences from the first example will be described here.

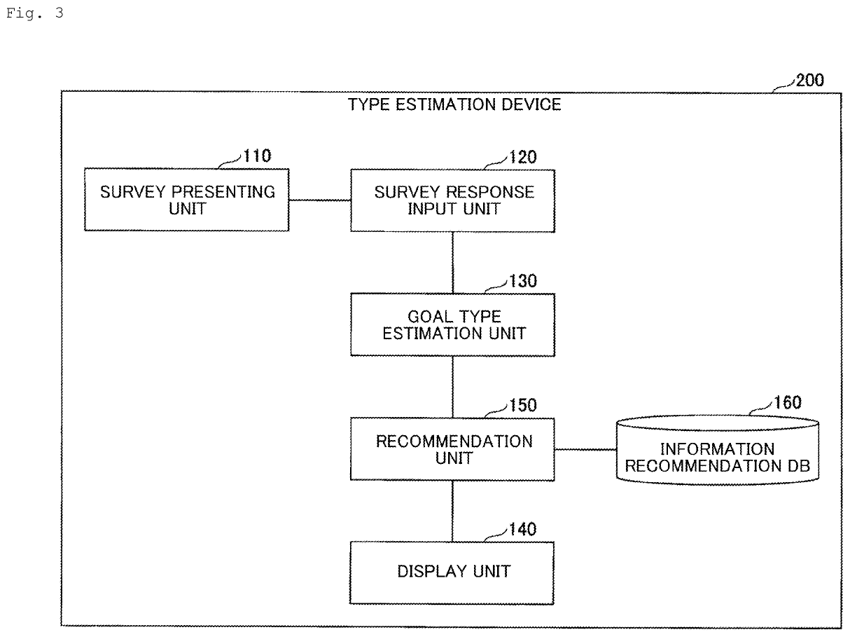

FIG. 3 is a block diagram illustrating a type estimation device 200 according to the variation on the first example. Note that the type estimation device 200 according to the variation on the first example may be called an “information recommendation device”. As illustrated in FIG. 3, the type estimation device 200 according to the variation on the first example includes the survey presenting unit 110, the survey response input unit 120, the goal type estimation unit 130, the display unit 140, a recommendation unit 150, and an information recommendation DB 160.

As illustrated in FIG. 3, the type estimation device 200 according to the variation on the first example adds the recommendation unit 150 and the information recommendation DB 160 to the type estimation device 100 of the first example.

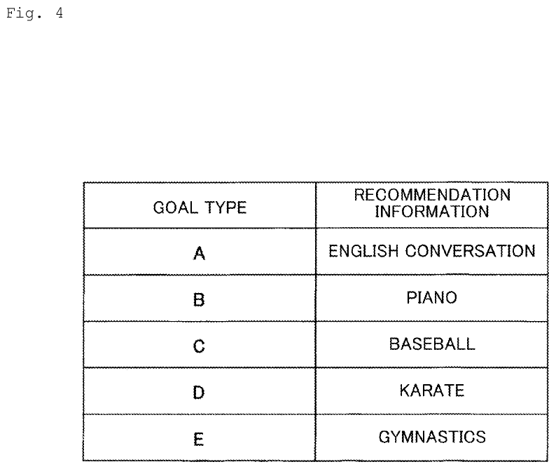

FIG. 4 illustrates an example of information stored in the information recommendation DB 160 according to the variation on the first example. As illustrated in FIG. 4, recommendation information is stored in the information recommendation DB 160 for each goal type. The recommendation information is an example of parenting behavior recommended to the user. The recommendation information stored in the information recommendation DB 160 may be created by hand, or may be generated automatically, as will be described later.

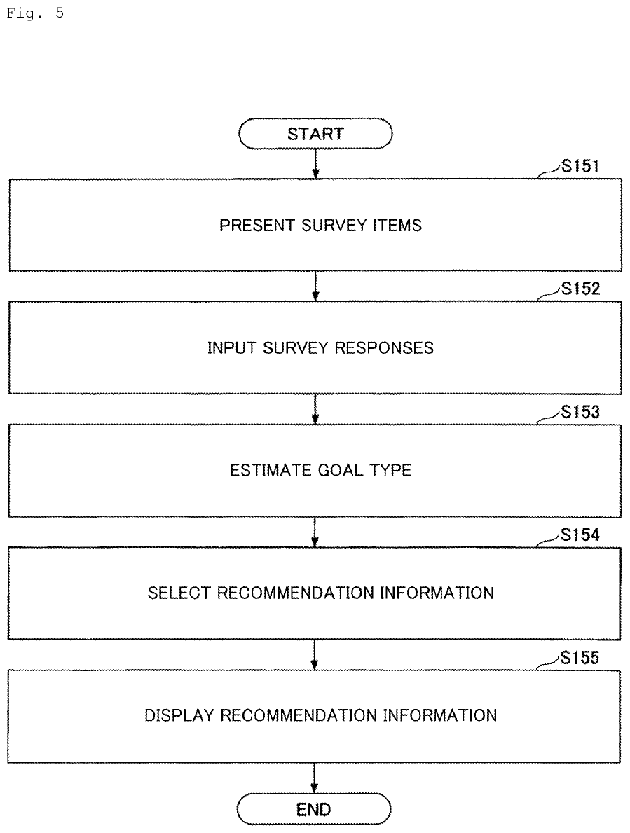

An example of operations of the type estimation device 200 having the above-described configuration will be described according to the order in the flowchart in FIG. 5.

The processing in S151 and S152 of FIG. 5 is the same as the processing of S101 and S102 of the first example and indicated in FIG. 2.

<S153>

In S153, the goal type estimation unit 130 performs goal type estimation in the same manner as in the first example, according to a predetermined estimation rule on the numerical value information of the responses to the survey. The goal type estimation unit 130 transmits the estimation result to the recommendation unit 150.

<S154>

In S154, the recommendation unit 150 searches the information recommendation DB 160 on the basis of the estimation result, selects recommendation information corresponding to the estimation result, and transmits the selected recommendation information to the display unit 140. For example, in the case of the information recommendation DB 160 illustrated in FIG. 4, assuming the estimation result is “goal type=A”, “English conversation” is selected as the recommendation information.

Although FIG. 4 illustrates recommendation information pertaining to “lessons” as an example of the parenting behavior in DB form, this is merely one example. Instead of “lessons”, or in addition to “lessons”, for example, “events”, “places to go out”, and the like may be put in DB form as the recommendation information and recommended as the recommendation information.

Additionally, although the example in FIG. 4 illustrates the information recommendation DB 160 as storing one instance of the recommendation information for a single goal type, this is merely an example. The information recommendation DB 160 may store a plurality of instances of the recommendation information for a single goal type.

<S155>

In S155, the display unit 140 displays the recommendation information obtained in S154. The user can therefore know parenting behavior suited to their own goal type, for example.

### Second Example

A second example will be described next. Mainly the differences from the first example will be described here. The configuration of the type estimation device 100 of the second example is the same as the configuration of the type estimation device 100 of the first example, and is as illustrated in FIG. 1.

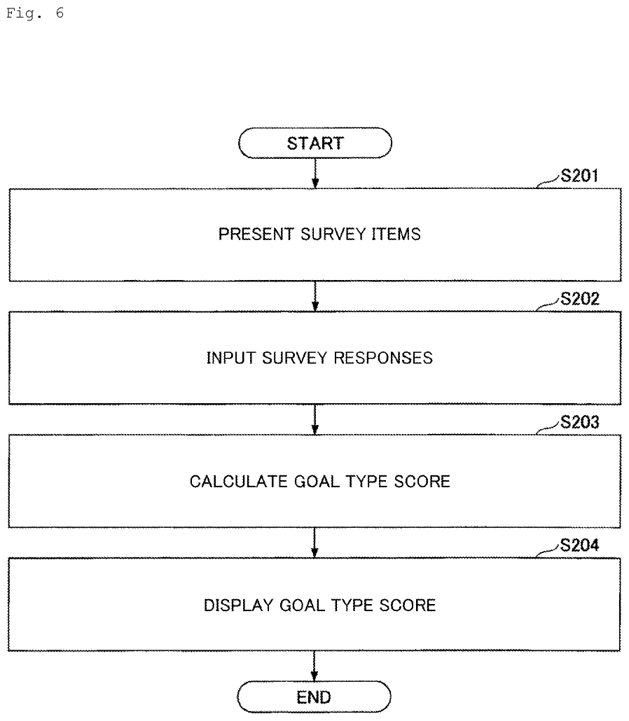

An example of operations of the type estimation device 100 of the second example, having the above-described configuration, will be described according to the order in the flowchart in FIG. 6.

The processing in S201 and S202 of FIG. 6 is the same as the processing of S101 and S102 of the first example and indicated in FIG. 2.

<S203>

In S203, the goal type estimation unit 130 calculates a score for each goal type according to a predetermined estimation rule using the survey response numerical value information, and transmits the score for each goal type to the display unit 140.

The method of calculating the score for each goal type is the same as the method of calculating the score for each goal type performed to estimate the goal type in the first example.

In other words, using, for example, the example of the above-described 41 questions, the average value of the response values for each of the five goal types is calculated, and each of the five average values then serves as a score corresponding to that goal type. The stated average values of the response values for each of the five goal types are the average value of the responses to questions 1 to 10, the average value of the responses to questions 11 to 17, the average value of the responses to questions 18 to 24, the average value of the responses to questions 25 to 32, and the average value of the responses to questions 33 to 41. As in the first example, additive values may be used instead of average values. Standardized values using the population mean value and standard deviation that have already been calculated may be used as well.

<S204>

In S204, the display unit 140 displays the score for each goal type obtained in S203. The user can therefore know the score for each of their own goal types, for example. Note that the goal type and the score for the goal type may be collectively referred to as the “goal type”.

(Variation on Second Example)

A variation on the second example will be described next. Mainly the differences from the second example will be described here.

The configuration of the type estimation device 200 of the variation on the second example is the same as the configuration of the type estimation device 200 of the variation on the first example, and is as illustrated in FIG. 3. Note that the type estimation device 200 of the variation on the second example, too, may be called an “information recommendation device”.

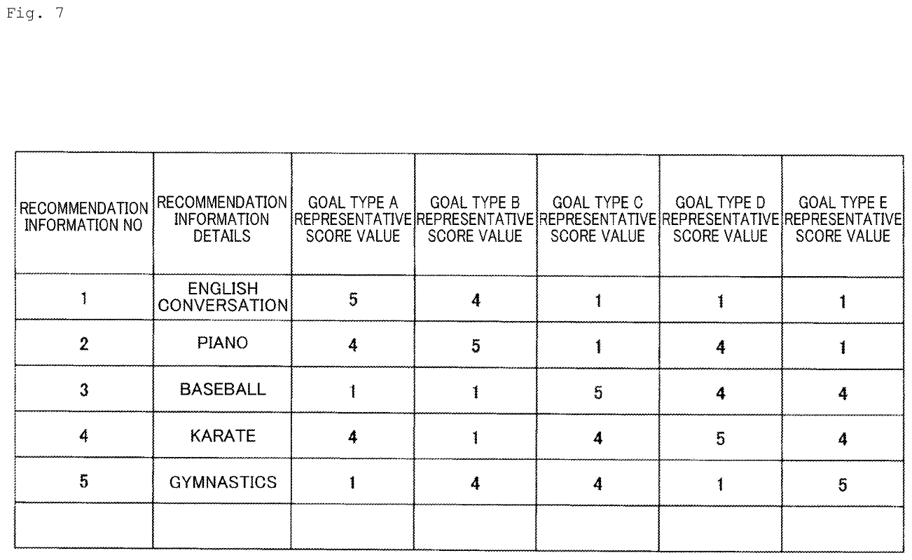

FIG. 7 illustrates an example of information stored in the information recommendation DB 160 according to the variation on the second example. As illustrated in FIG. 7, a recommendation information No, recommendation information details, and a representative score value for each goal type are stored in the information recommendation DB 160. The recommendation information (the recommendation information No and the recommendation information details) is an example of parenting behavior recommended to a subject close to goal types A to C. The information stored in the information recommendation DB 160 may be created by hand, or may be generated automatically, as will be described later.

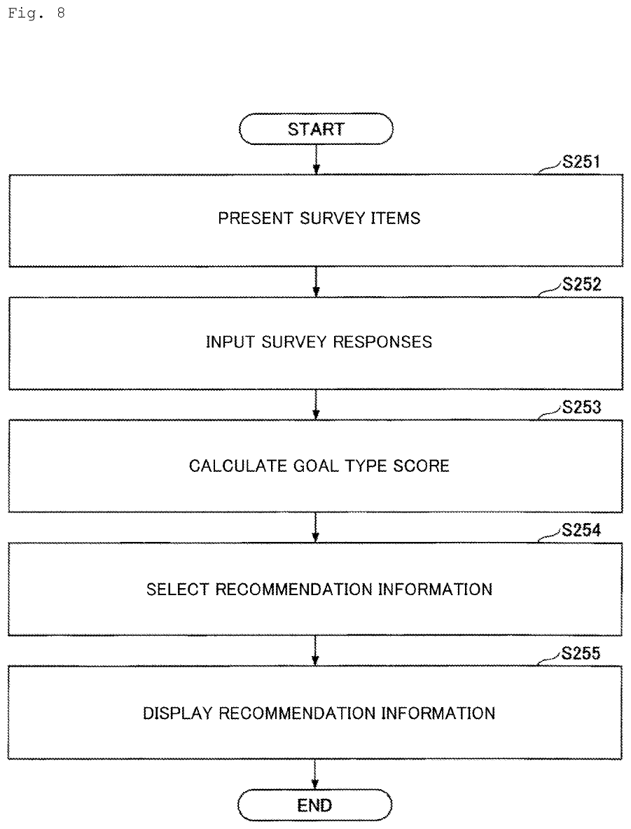

An example of operations of the type estimation device 200 according to the variation on the second example will be described according to the order in the flowchart in FIG. 8.

The processing in S251 and S252 of FIG. 8 is the same as the processing of S201 and S202 of the second example and indicated in FIG. 6.

<S253>

In S253, the goal type estimation unit 130 calculates the score for each goal type in the same manner as the calculation of the score for each goal type in the second example (S203 in FIG. 6), and transmits a result of the calculation to the recommendation unit 150.

<S254>

On the basis of the score for each of the goal types of the user, the recommendation unit 150 refers to the information recommendation DB 160, selects the recommendation information that is closest in distance to the score for each of the goal types, and transmits the selected recommendation information to the display unit 140.

To be more specific, for example, the recommendation unit 150 first refers to the information recommendation DB 160, and uses the following formula to calculate a Euclidean distance between each instance of recommendation information in the information recommendation DB 160 and the score obtained for each goal type in S253.

dₙ=(p_{A}−q_{A})²+(p_{B}−q_{B})+(p_{C}−q_{C})²+(p_{D}−q_{D})²+(p_{E}−q_{E})² [Math 1]

pₐ, p_{b}, p_{c}, p_{d}, and pₑ in the above formula represent a goal type A representative score value, a goal type B representative score value, a goal type C representative score value, a goal type D representative score value, and a goal type E representative score value, respectively, for the recommendation information in the information recommendation DB 160. Additionally, qₐ, q_{b}, q_{c}, q_{d}, and qₑ represent the scores for each of the goal types (A to E) of the user, obtained in S253.

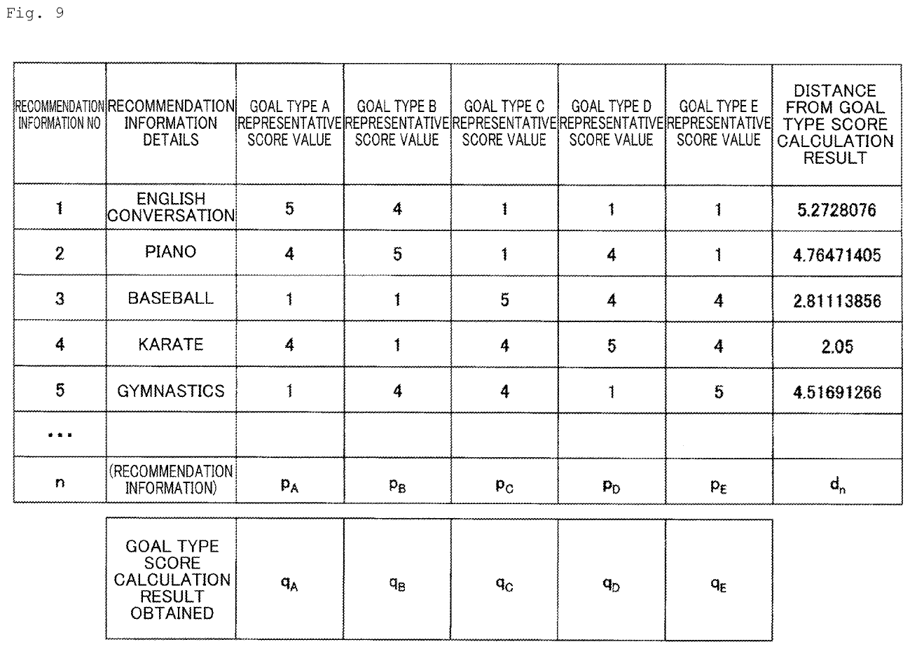

FIG. 9 illustrates values of the distance from each instance of recommendation information calculated when the scores for each goal type are (type A=3.2, type B=2, type C=4, type D=3.75, and type E=3), as one example.

The recommendation unit 150 selects the recommendation information that is closest in distance to the score for each goal type. In the example in FIG. 9, the recommendation information of No. 4 is selected.

Although a Euclidean distance is used in the above-described example, using a Euclidean distance is merely one example. Any distance may be used as long as the magnitude of the distance between the score for each of the goal types and each instance of recommendation information can be determined. For example, a value obtained by adding the square of the difference between the score for each of the goal types and a value of each instance of the recommendation information (representative score value for each goal type) may be used (the root is removed in the above formula). A Manhattan distance or the like may be used as well.

Additionally, all the goal types A to E need not be used to calculated the distance. For example, only the highest three scores among the scores for each of the goal types of the user may be used in the calculation. For example, when (type A=3.2, type B=2, type C=4, type D=3.75, and type E=3), only types C, D, and A are used in the calculation.

Additionally, only the scores, among the scores for each of the goal types of the user, which are greater than or equal to a median value of the options (e.g., greater than or equal to 3 if the options are 1 to 5) may be used, or only the scores which are greater than the population mean may be used, or the goal types A to E to be used in the calculation may be selected using a different method instead.

<S255>

In S255, the display unit 140 displays the recommendation information obtained in S254. The user can therefore know parenting behavior suited to trends in their own goal type, for example.

Note that selecting parenting behavior (recommendation information) in consideration of a balance among the scores for each of the goal types, as in the variation on the second example, is based on result (3) in Experiment 1.

Additionally, for the variation on the first example and the variation on the second example, in which recommendation information is presented, the “parenting behavior” as information to be selected and presented as recommendation information may belong to any of the following: “what kind of parent do you want to be?”, “what do parents do for their children?”, “what do parents not do for their children?”, “what do you want your children to do?”, and “what do you want your children not to do?”.

Additionally, for the variation on the first example and the variation on the second example, in which recommendation information is presented, the “parenting behavior” as information to be selected and presented as recommendation information may belong to any of the following: parenting attitude (e.g., a guiding attitude), parenting behavior (e.g., whether the parent behaves in a way that exposes the child to various stimuli), and lessons to be taught in the future, as indicated in result (3) of Experiment 1.

Additionally, for the variation on the first example and the variation on the second example, in which recommendation information is presented, the “parenting behavior” as information to be selected and presented as recommendation information may belong to any of the following three items: “behavior communicating affection”, “stimulating behavior”, and “disciplinary behavior”, as indicated in result (3) of Experiment 2.

### Third Example

A third example will be described next. The third example will describe a method for generating the information recommendation DB 160 described in the variation on the first example and the variation on the second example.

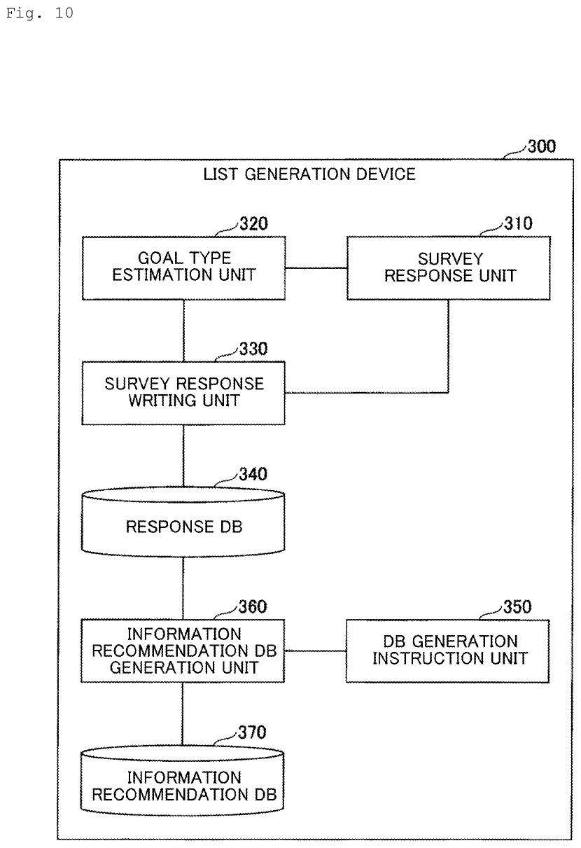

FIG. 10 is a block diagram illustrating a list generation device 300 according to the third example. As illustrated in FIG. 10, the list generation device 300 of the third example includes a survey response unit 310, a goal type estimation unit 320, a survey response writing unit 330, a response DB 340, a DB generation instruction unit 350, an information recommendation DB generation unit 360, and an information recommendation DB 370.

Note that the list generation device 300 may be the same device as the type estimation device 200 (FIG. 3) described in the variation on the first example and the variation on the second example. In this case, the type estimation device 200, to which the survey response writing unit 330, the response DB 340, the DB generation instruction unit 350, and the information recommendation DB generation unit 360 have been added to the configuration illustrated in FIG. 3, functions as the list generation device 300. In this case, the information recommendation DB 370 is the information recommendation DB 160 in FIG. 3.

However, the list generation device 300 may be a different device from the type estimation device 200 (FIG. 3) described in the variation on the first example and the variation on the second example. In this case, information stored in the information recommendation DB 370 as a calculation result in the list generation device 300 is sent to the type estimation device 200 over a network, for example, and is stored in the information recommendation DB 160 of the type estimation device 200.

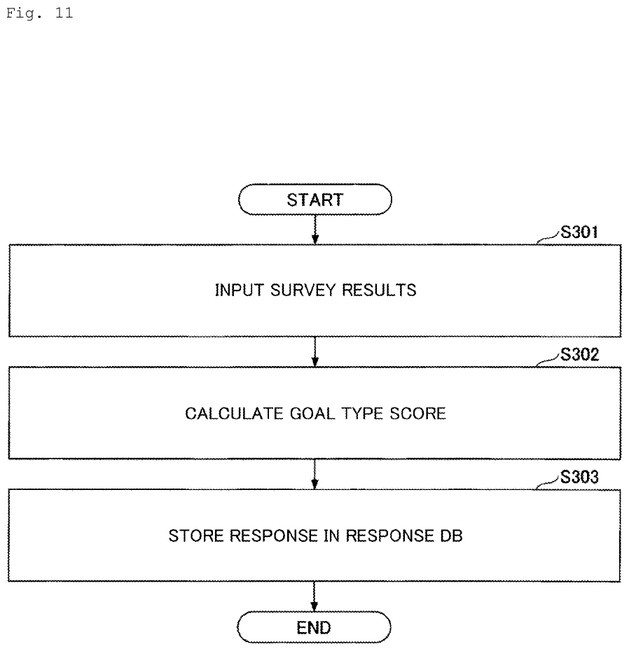

First, an example of operations involved in the accumulation of responses, performed in the list generation device 300 having the above-described configuration, will be described according to the order in the flowchart in FIG. 11.

<S301>

In S301, the user inputs results of a goal type estimation survey, as well as results of a survey pertaining to the actual current parenting behavior of the user (e.g., lessons), from the survey response unit 310. The results of the goal type estimation survey that have been input are transmitted to the goal type estimation unit 320. The results of the survey pertaining to parenting behavior (e.g., lessons) are transmitted to the survey response writing unit 330.

An example of the goal type estimation survey is the same as that described in the first example and the like. The survey pertaining to actual current parenting behavior (e.g., lessons) is a survey pertaining to information to be recommended, and is a survey including questions such as what kind of lessons are being taken, how often, and the like.

Although a survey pertaining to parenting behavior is used in the above-described example, this is merely an example. For example, a survey about “books and articles I enjoyed reading” may be used instead of parenting behavior.

<S302>

In S302, the goal type estimation unit 320 calculates a score for each of the goal types, in the same manner as the goal type estimation unit 130 according to the second example (or the first example). The calculated score for each of the goal types is transmitted to the survey response writing unit 330.

<S303>

In S303, the survey response writing unit 330 transmits, to the response DB 340, the score for each of the goal types input from the goal type estimation unit 320 and the information pertaining to parenting behavior input from the survey response unit 310. The response DB 340 stores the received responses.

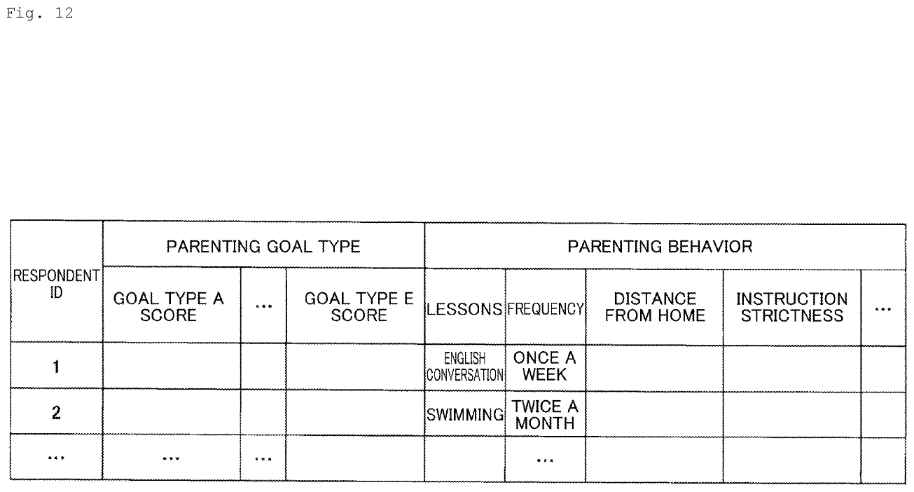

FIG. 12 illustrates an example of the information stored in the response DB 340. As illustrated in FIG. 12, a score for each parenting goal type, the content, frequency, and the like of “lessons” as an example of the parenting behavior, and the like are stored in the response DB 340 for each respondent (respondent ID).

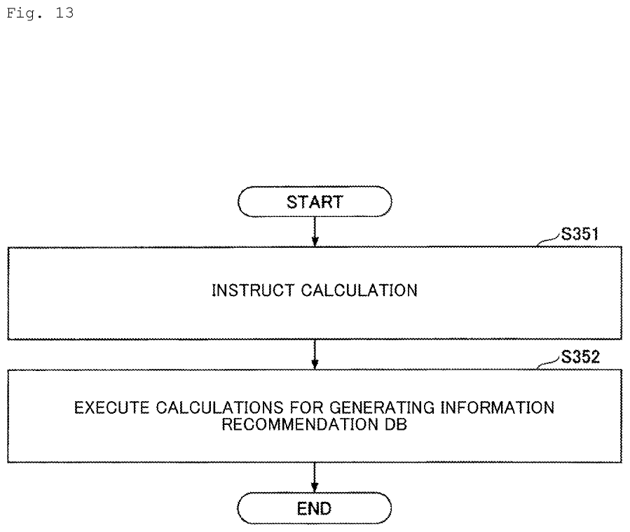

Next, an example of operations involved in the generation of the information recommendation DB, performed in the list generation device 300, will be described according to the order in the flowchart in FIG. 13.

<S351>

In S351, the DB generation instruction unit 350 makes a calculation instruction to the information recommendation DB generation unit 360 for generating the information recommendation DB. In other words, the DB generation instruction unit 350 transmits calculation instruction information for generating the information recommendation DB to the information recommendation DB generation unit 360.

<S352>

In S352, having received the calculation instruction information, the information recommendation DB generation unit 360 queries the response DB 340, performs a calculation on the basis of the information accumulated in the response DB 340, generates information for storing in the information recommendation DB 370, and stores the generated information in the information recommendation DB 370.

The trigger for the calculation by the information recommendation DB generation unit 360 (including recalculations) need not be the reception of the calculation instruction. For example, each time information of a survey result is input to the response DB 340, the response DB 340 may transmit the information of the response DB 340 to the information recommendation DB generation unit 360, and the calculation may be performed using the reception of that information by the information recommendation DB generation unit 360 as a trigger. The calculation may also be performed when a set number of surveys (e.g., ten) have been responded to by users.

When the type estimation device 200 functions as the list generation device 300, the information recommendation DB generation unit 360 may perform the calculation for generating the information recommendation DB when the information recommendation DB 160 is queried (when the recommendation unit 150 selects the recommendation information). Specific examples of the calculations performed by the information recommendation DB generation unit 360 will be described hereinafter.

### Example 1

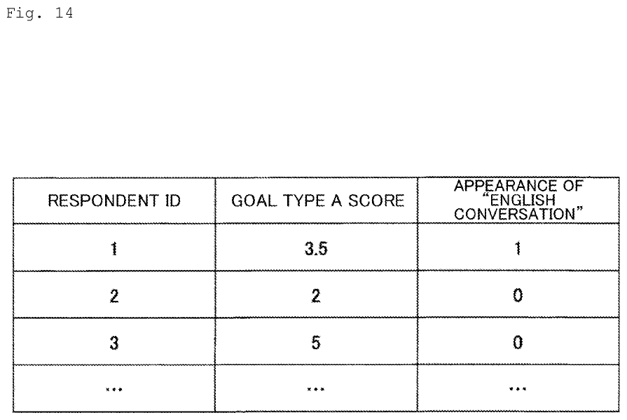

When generating the information of the information recommendation DB according to the variation on the first example (e.g., FIG. 4), the information recommendation DB generation unit 360 generates the information of the information recommendation DB (e.g., FIG. 4) by calculating a point biserial correlation coefficient between the score for each of the goal types and each of the lessons on the basis of the information illustrated as an example in FIG. 14.

For example, when the point biserial correlation coefficient between a given goal type and a given lesson is written as “goal type×lesson”, the information recommendation DB generation unit 360 calculates the point biserial correlation coefficient between the score for each of the goal types and each of the lessons as goal type A×English conversation, goal type B×English conversation, . . . , goal type A×calligraphy, goal type B×calligraphy, and so on. The information recommendation DB generation unit 360 then associates the lesson having the highest positive correlation with each of the goal type, and writes the lesson having the highest correlation into the information recommendation DB 370 as the recommendation information corresponding to that goal type. For example, when “English conversation” has the highest positive correlation with goal type A, “English conversation” is stored in the information recommendation DB 370 for goal type A, as illustrated in FIG. 4.

Note that the use of point biserial correlation is merely an example. Any calculation method may be used as long as it is a calculation method that makes it possible to express correlation between target type scores and lessons.

Additionally, although the foregoing example describes “associating the lesson having the highest positive correlation with a goal type and writing the information into the information recommendation DB 370”, this is merely an example. The information recommendation DB 370 may be generated through a different method.

For example, the “highest positive correlation” in the “associating the lesson having the highest positive correlation with a goal type and writing the information into the information recommendation DB 370” may be replaced with “a correlation greater than or equal to a reference value”.

A test of significance may be performed, and an item for which a correlation has been found may be used. In this case, the “highest positive correlation” in the “associating the lesson having the highest positive correlation with a goal type and writing the information into the information recommendation DB 370” may be replaced with “performing a test of significance using an item for which a correlation has been found”.

Additionally, the information recommendation DB 370 may be generated by associating a goal type having a high positive correlation with a lesson.

### Example 2

When the information of the information recommendation DB according to the variation on the second example (e.g., FIG. 7) is generated, the information recommendation DB generation unit 360 calculates, for each lesson, the average value of the scores for each of the goal types, and writes that value into the information recommendation DB 370 as the representative score value for each of the goal types.

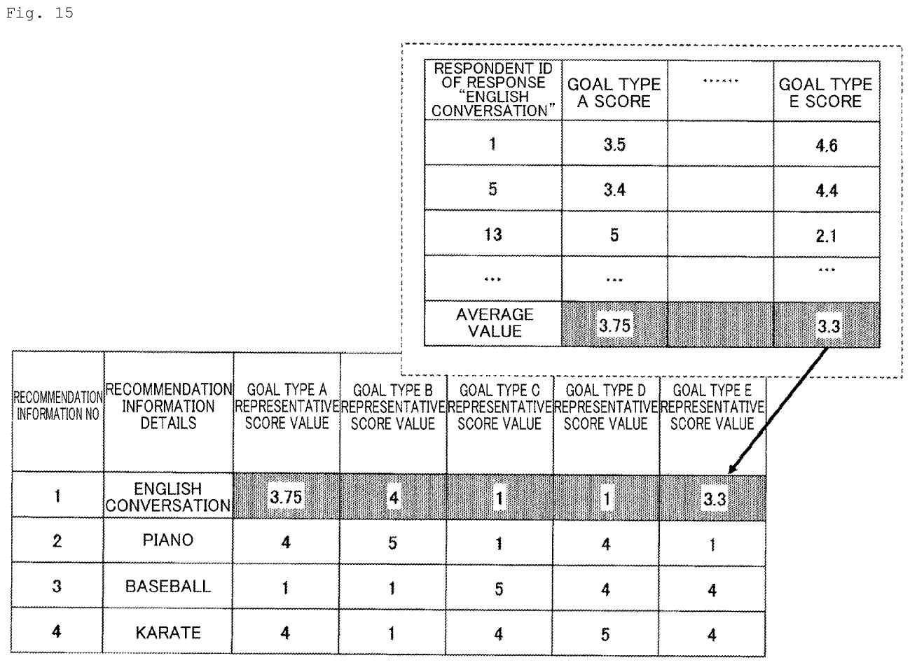

For example, in the example illustrated in FIG. 15, the average value of the score of goal type E for the respondent who responded with “English conversation” is 3.3, so 3.3 is written as the “goal type E representative score value” in the row “recommendation information=English conversation” in the information recommendation DB 370.

Although the average value of the score for each of the goal types is calculated in the above example, this is merely an example. Any calculation method may be used as long as a value which can indicate a representative value for each goal type is obtained.

Additionally, for each lesson, the information recommendation DB generation unit 360 may calculate the average value and standard deviation of the scores for each of the goal types to derive items having a low level of relation between the goal type and the lesson, and the column for (lesson, goal type) where the standard deviation is greater than the standard may be set to “null” in the information recommendation DB 370.

According to the third example, the information recommendation DB can be generated automatically on the basis of a survey.

(Example of Hardware Configuration)

Any of the type estimation device 100, the type estimation device 200, and the list generation device 300 according to the present embodiment can be realized by, for example, causing a computer to execute a program in which is written the processing content described in the present embodiment. Note that this “computer” may be a physical machine or a virtual machine in the cloud. When a virtual machine, the “hardware” described here is virtual hardware.

The stated program can be recorded into a computer-readable recording medium (portable memory or the like), stored, distributed, and the like. The program can also be provided over a network, such as using the Internet, email, and the like.

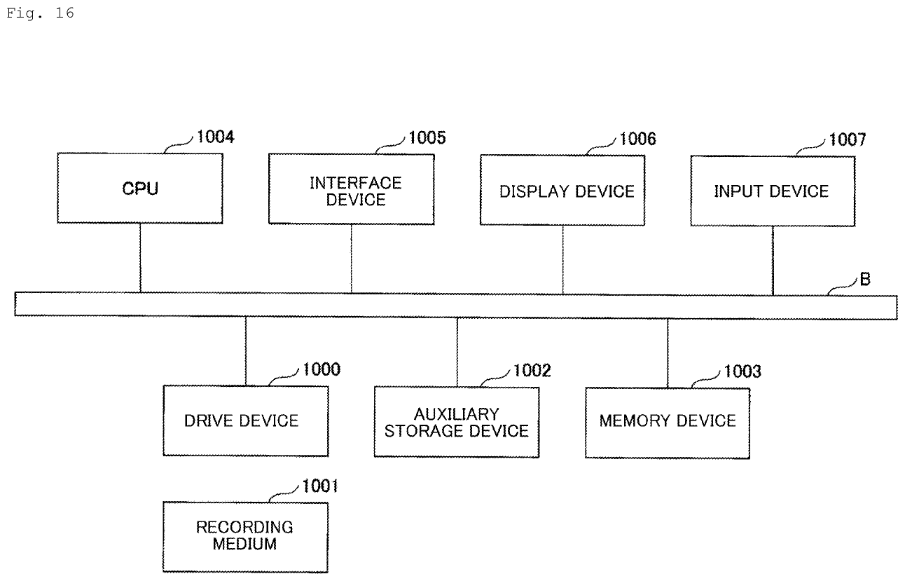

FIG. 7 is a diagram illustrating an example of the hardware configuration of the computer. The computer in FIG. 16 includes a drive device 1000, an auxiliary storage device 1002, a memory device 1003, a CPU 1004, an interface device 1005, a display device 1006, an input device 1007, and the like, which are connected to each other by a bus BS.

The program that implements the processing in the computer is provided, for example, using a recording medium 1001, which is a CD-ROM, a memory card, or the like. When the recording medium 1001 storing the program is set in the drive device 1000, the program is installed into the auxiliary storage device 1002 from the recording medium 1001 via the drive device 1000. However, it is not absolutely necessary to install the program from the recording medium 1001, and the program may instead be downloaded from another computer over a network. The auxiliary storage device 1002 stores the installed program as well as required files, data, and the like.

The memory device 1003 reads out the program from the auxiliary storage device 1002 and stores the program when there is an instruction to launch the program. The CPU 1004 implements the functions corresponding to the device in accordance with the program stored in the memory device 1003. The interface device 1005 is used as an interface for connecting to a network. The display device 1006 displays a Graphical User Interface (GUI) and the like of the program. The input device 1007 is constituted by a keyboard, a mouse, buttons, a touch panel, or the like, and is used to input various operation instructions.

(Effects, etc. of Embodiment)

As described thus far, the technique according to the present embodiment makes it possible to estimate a type of a parenting goal of a person raising a child by having that person respond to a plurality of questions. Information suited to the goal type can then be recommended on the basis of the estimated parenting goal type. An information recommendation DB for recommending information on the basis of a survey can also be generated and updated.

(Summary of Embodiment)

At least the type estimation device, the type estimation method, and the program according to the following items are described in the present specification.

### (Item 1)

A type estimation device, including:

an input unit that inputs a response by a user to a predetermined question for estimating a parenting goal type of the user; and

a goal type estimation unit that estimates the parenting goal type of the user on the basis of the response,

wherein the predetermined question is a question about what kind of person the user wants a child to become in the future or what kind of person the user does not want a child to become in the future.

### (Item 2)

The type estimation device according to item 1, further including:

a recommendation unit that recommends a parenting behavior suited to the parenting goal type of the user on the basis of information indicating a relationship between parenting goal types and parenting behavior stored in an information recommendation database and the parenting goal type estimated by the goal type estimation unit.

### (Item 3)

The type estimation device according to item 1 or item 2, further including:

a generation unit that generates information indicating a relationship between parenting goal types and parenting behavior on the basis of a first response that is a response by the user to the predetermined question for estimating the parenting goal type of the user and a second response that is a response regarding parenting behavior actually being performed by the user, and stores the information in an information recommendation database.

### (Item 4)

The type estimation device according to item 3 dependent on item 2,

wherein the recommendation unit according to item 2 recommends the parenting behavior suited to the parenting goal type of the user using the information recommendation database storing the information generated by the generation unit according to item 2.

### (Item 5)

A type estimation method executed by a type estimation device, the type estimation method including:

an input step of inputting a response by a user to a predetermined question for estimating a parenting goal type of the user; and

a goal type estimation step of estimating the parenting goal type of the user on the basis of the response,

wherein the predetermined question is a question about what kind of person the user wants a child to become in the future or what kind of person the user does not want a child to become in the future.

### (Item 6)

A program that causes a computer to function as the units of the type estimation device according to any one of items 1 to 4.

About the Experiments

The following will describe Experiment 1 and Experiment 2 mentioned at the beginning of the specification.

<Purpose of Experiment 1>
Parenting goals that influence parenting behavior differ from person to person, and by extracting these in a simple and appropriate manner, they can be used to propose parenting information and services that match individual values.

Based on the stated perspective, the following (1) to (3) were established as the approach (objective) of Experiment 1.

(1) Extracting the components of parenting goals

(2) Classifying mothers by the type of their parenting goals

(3) Confirming the relationship between each parenting goal type and parenting behavior

<Methodology of Experiment 1>

The investigation methodology was as follows.
Method: online survey (February-March, 2018)
Participants: 306 (mothers with 1- to 2-year old children)
Survey items:

Items related to parenting goals: 119 items (1 to 5 rating scale)

Items related to parenting behavior (attitudes, behaviors, focus on lessons)

The analysis methodology was as follows.

(1) Factor analysis was used to extract the components of the parenting goals. The items were examined, and 64 items were ultimately used for the analysis. The maximum likelihood method and Promax rotation were used.

(2) Cluster analysis was used to classify mothers by the type of parenting goal. Specifically, a factor score for each participant was calculated for the results found in the factor analysis, and the participants were classified according to a combination of the factor scores.

(3) Variance analysis was used to confirm the relationship between each type and parenting behavior. Specifically, differences in mothers' responses to “items related to parenting behavior” were examined for each cluster.

<Results (1) and (2) of Experiment 1>

(1) Results of “extracting the components of parenting goals”

Six factors were extracted for parenting goals. The survey items were examined closely, and by performing factor analysis using the 64 items, individual-oriented developmental goals (Factors (1) and (3)), group-oriented developmental goals (Factor (5)), relationship-building goals (Factors (2) and (4)), and the like were extracted.

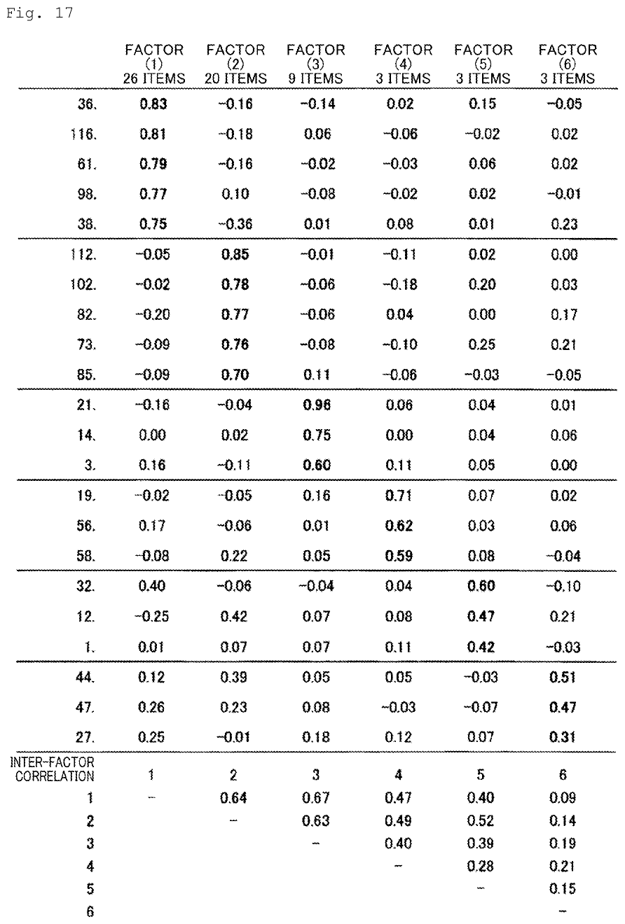

The analysis results are shown in FIG. 17. Factors (1) to (6) on the upper side of FIG. 17 are as follows.

Factor (1): a person who can take on the challenge of what they want to do

Factor (2): a person who can build good relationships with society and others

Factor (3): a person who can think and act independently

Factor (4): a person who can build a good parent-child relationship

Factor (5): a person who has warmth for others

Factor (6): a person who can lead a good life

The numbers on the left side indicate the question items, each of which is as follows.

36. I want them to become a person who takes on big challenges

116. I want them to become a person who can create (think and create by themselves)

61. I want them to become a person who is deeply interested in and deeply enjoys something particular

98. I want them to become a person who follows through with their decisions

38. I want them to become a person who does what they want to do without worrying about what others think of them

. . . (omitted)

112. I want them to become a person with good social manners

102. I want them to become a polite person

82. I want them to build a happy household

73. I want them to become a person who can appreciate the people around them

85. I want them to become a person who does not cause trouble for others or society

. . . (omitted)

21. I want them to become a person who can think of their own ways to achieve their goals

14. I want them to become a person who can think and decide for themselves for everything

3. I want them to become a person who can think of and execute their own measures for addressing current dissatisfactions

. . . (omitted)

19. I want my child to know that their parents are there to help them through hard times

56. I want them to think they can rely on their parent in times of trouble

58. I want to build a relationship so that they will talk to me if something happens

. . . (omitted)

32. I want them to become a person who can work hard for others

12. I want them to become a compassionate person

1. I want them to become a person who has kind words for everyone

. . . (omitted)

44. I want them to live their life in a way that satisfies them

47. I want them to find the work they want to do by themselves

27. I want my child to choose their lifestyle by putting their desires and dreams first

. . . (omitted)

(2) Results for “Classifying by the type of parenting goals”

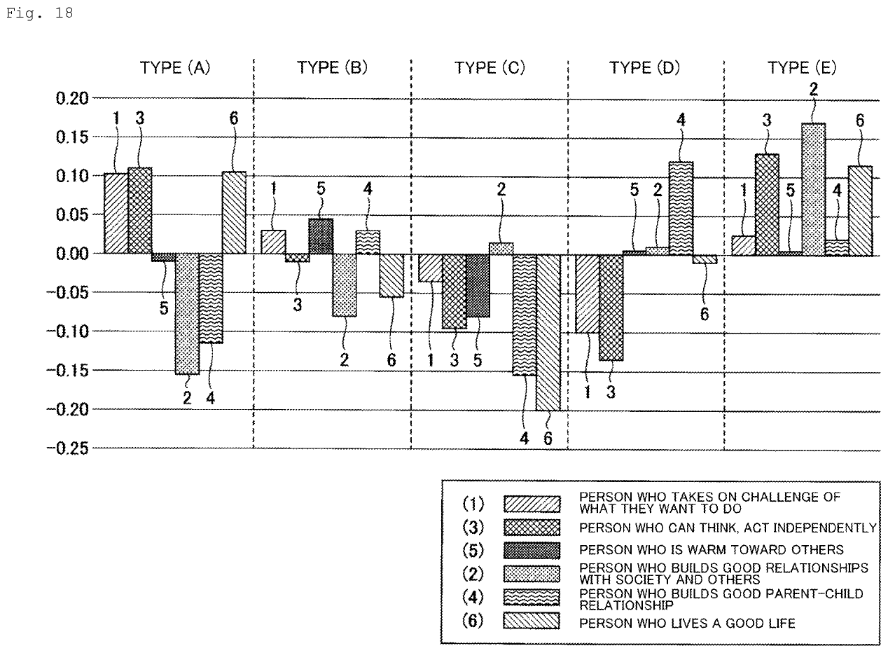

Mothers were classified into five types according to how they hold their parenting goals. More specifically, as illustrated in FIG. 18, cluster analysis was used to classify patterns of parenting goals based on combinations of factor scores, with the goal of dividing the mothers into types (Ward method, Euclidean distance).

In FIG. 18, the Types (A) to (E) are as follows.

Type (A): type who wants their child to build a good life through personal progress

Type (B): type focused on warmth

Type (C): type focused on their child living well in society

Type (D): type focused on parent-child relationships

Type (E): type who wants their child to build a good life by being independent and accepted by society

<Purpose of Experiment 2>

It has been pointed out that there are cultural differences in parenting goals and behaviors, that parents may engage in different parenting behaviors even if they have the same parenting goals, or may engage in the same parenting behaviors even if they have different parenting goals (Suizzo, 2002). However, there is little research on parenting goals held by parents of infants in Japan. The purpose of Experiment 2, therefore, was to investigate the relationship between parenting goals and parenting behavior in Japan.

<Methodology of Experiment 2>

The investigation methodology was as follows.
Method: online survey
Participants: 765 mothers of children ages 1 to 3 (average age 33.5, SD 4.97 years)
The questionnaire was as follows.
Parenting goals: 167 items evaluated on a five-point scale (“1 disagree” to “5 very strongly agree”); a survey about what kind of person the parents wants/doesn't want their child to become in the future, consisting of items developed on the basis of interviews.
Parenting behavior: 60 items evaluated on a four-point scale (“1 rarely” to “4 always”); a survey consisting of items from previous research (Suizzo, 2002) and items developed with reference to interviews about life with children.

<Results (1), (2), and (3) of Experiment 2>

(1) Results for factors of parenting goals
Factor analysis (maximum likelihood method, Promax rotation) was performed on 41 items, deleting items in light of inter-item correlations and factor loadings, and five factors (Factor 1 to Factor 5) were extracted. The sum of the scores of the items included in a factor was used as the parenting goal score. The factor names, a summary, and example items for each resulting factor are listed below.

Factor name of Factor 1 (10 items): improvement of personal abilities

Summary of Factor 1: becoming a person with the ability and mindset to be independent, assertive, and able to do what they want in the future

Examples of items in Factor 1: “I want them to become able to express themselves in their own way and not settle for the usual”, “I want them to become a person who can express their opinions openly”, and the like

Factor name of Factor 2 (7 items): good parent-child relationship

Summary of Factor 2: establishing a loving and trusting relationship with parents in the future

Examples of items in Factor 2: “I want them to feel reassured that they have a parent (me) they can rely on in times of trouble”, “I want them to have a loving relationship with their parent (me)”, and the like

Factor name of Factor 3 (7 items): good relationship with others

Summary of Factor 3: to be accepted by many different people and build good interpersonal relationships in the future

Examples of items in Factor 3: “I want them to become a person loved by everyone”, “I want them to become a person who gets along with everyone”, and the like

Summary of Factor 4 (8 items): warmth toward others

Summary of Factor 4: to become a person with the mindset to care for and act on behalf of others in the future

Examples of items in Factor 4: “I want them to become a person who cares about others”, “I want them to become a person who can understand another person's position”, and the like

Summary of Factor 5 (9 items): seriousness about life

Summary of Factor 5: to be a solid person, not corrupt, with a positive attitude toward life, and the like in the future

Examples of items in Factor 5: “I don't want them to become a person who lives a lazy life”, “I want them to become a person with common sense (the opposite)”, and the like

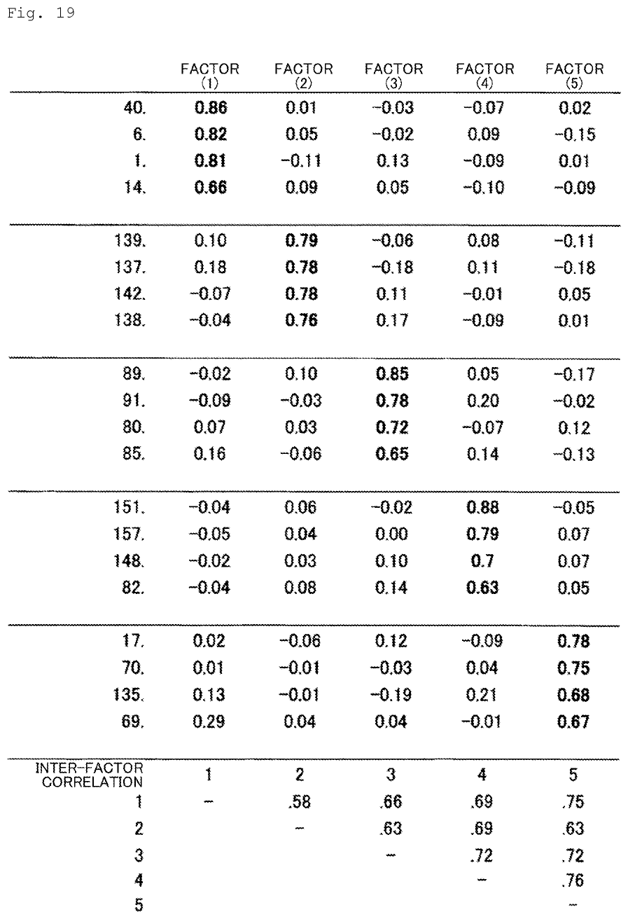

FIG. 19 shows the results of the factor analysis based on the above-described results. The Factors 1 to 5 on the upper side of FIG. 19 are the Factors 1 to 5 described above.

The numbers on the left side indicate the question items, each of which is as follows.

40. I want them to become able to express themselves in their own way and not settle for the usual

6. I want them to become a person who can dive into anything they want to do without hesitation

1. I want them to become a person who takes on big challenges

14. I want them to become a person who is deeply interested in something particular

. . . (omitted)

139. I want them to feel reassured that they have a parent (me) they can rely on in times of trouble

137. I want them to think they can rely on their parent (me) in times of trouble

142. I want them to have a loving relationship with their parent (me)

138. I want them to work with me to build a parent-child relationship where they can talk to their parent (me) if something happens

. . . (omitted)

89. I want them to become a person loved by everyone

91. I want them to become a person who gets along with everyone

80. I want them to become a person who is accepted by many different people

85. I want them to build many friendships

. . . (omitted)

151. I want them to become a person who cares about others

157. I want them to become a person who has warm feelings toward others

148. I want them to become a person who can understand another person's position

82. I want them to become a person who cares about their friends

. . . (omitted)

71. I don't want them to become a person who lives a lazy life

70. I don't want them to become an apathetic person

135. I don't want them to become a person who leaves things to others and doesn't make any effort on their own

69. I don't want them to become a corrupt person without ambition

Correspondence relationships between Types (A) to (E) in Experiment 1 and Factors 1 to 5 in Experiment 2 are as follows.

Factor 1 (I want them to develop their abilities and become an independent person)=Type (A) (type who wants them to build a good life through personal progress)

Factor 2 (I want them to become a person who has a trusting relationship with their parents)=Type (D) (type focused on parent-child relationships)

Factor 3 (I want them to become a person who can build good relationships with the people around them)=Type (C) (type focused on them living well in society)

Factor 4 (I want them to become a person who is kind to others)=Type (B) (type focused on warmth)

Factor 5 (I want them to become a decent member of society)=Type (E) (type who wants them to build a good life by being independent and accepted by society)

(2) Results for factors of parenting behavior
Factor analysis was performed on 60 items for analysis (the maximum likelihood method, Promax rotation), and three factors were extracted. Items with a factor loading of greater than or equal to 0.5 for each factor were extracted, and the sum of these scores was used as a parenting behavior score. The factor names and example items for each resulting factor are listed below.

Factor name of Factor 1 (10 items): behavior expressing affection

Examples of items in Factor 1: “I try to have a lot of physical contact with my child”, “I always soothe my child when they cry”, and the like

Factor name of Factor 2 (7 items): stimulating behavior

Examples of items in Factor 2: “I let my child experience many things that other children do not”, “I show my child artistic works”, and the like

Item name of Factor 3 (3 items): disciplinary behavior

Examples of items in Factor 3: “I teach my child to stay calm in public places like stores”, “I'm not at the mercy of my child”, and the like

(3) Results on the relationship between parenting goals and behavior

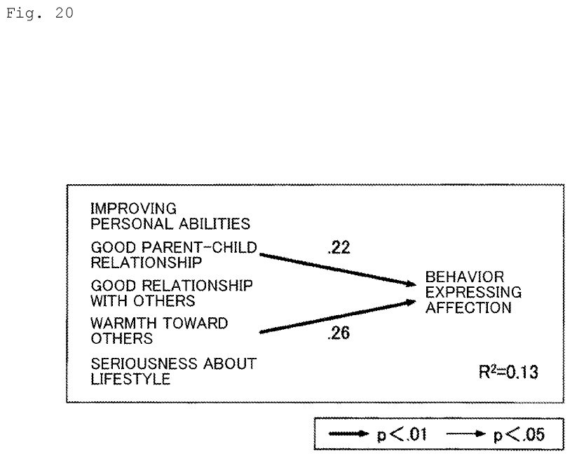

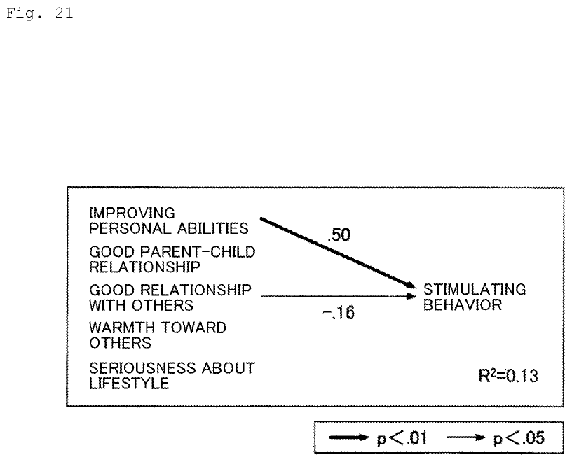

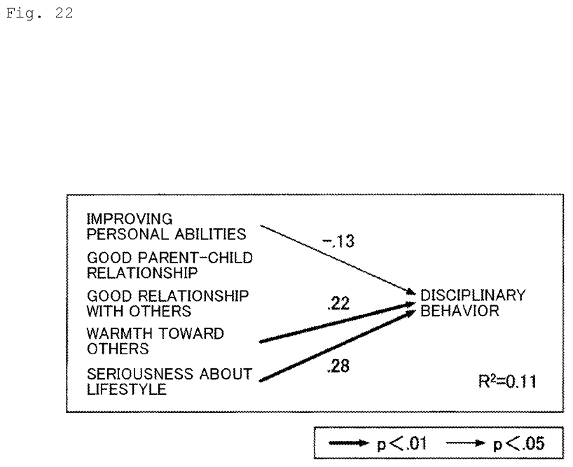

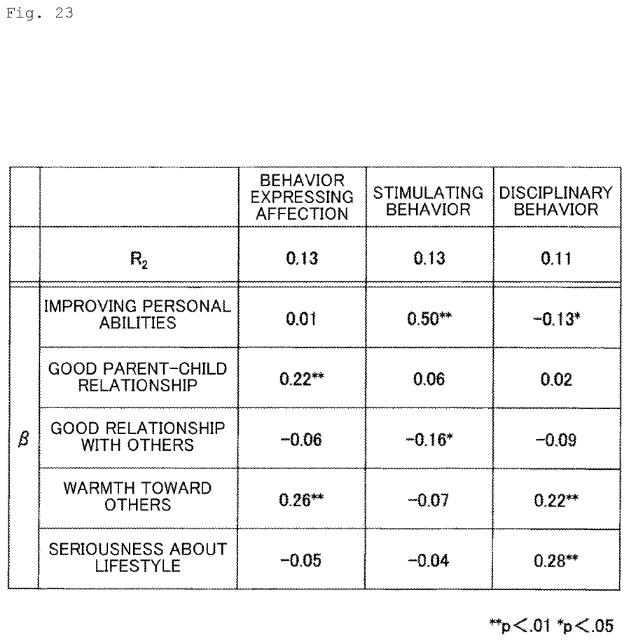

For each of the three parenting behaviors, a multi regression analysis (forced imputation method) with the five parenting goal scores as independent variables was performed to confirm the relationship with the five parenting goals. FIGS. 20 to 22 are shown as clear illustrations of the relationship between parenting goals and behavior, and the results in tabular form are shown in FIG. 23.

<Result (3) of Experiment 1>

Results for (3) “confirming the relationship between each parenting goal type and parenting behavior” in Experiment 1

It was confirmed that parenting attitudes and behavior, thoughts about lessons they wish their children to take in the future, and the like vary depending on the type of the parenting goals of the mother.

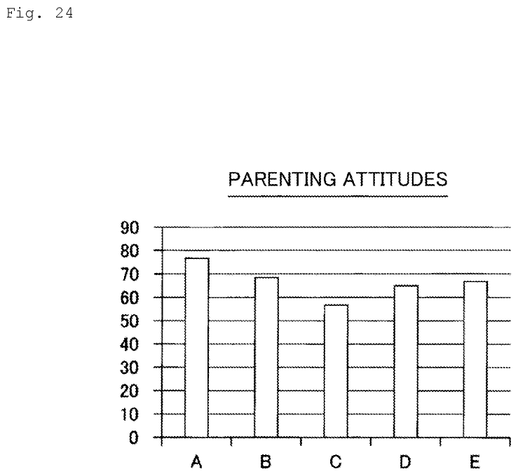

Responses pertaining to parenting attitudes, behaviors, and thoughts about lessons they wish their children to take in the future were compared for each cluster (type), and the main differences that were found are shown in FIGS. 24 to 27. A to E in each figure indicates the types in Experiment 1, as follows.

Type (A): type who wants their child to build a good life through personal progress

Type (B): type focused on warmth

Type (C): type focused on their child living well in society

Type (D): type focused on parent-child relationships

Type (E): type who wants their child to build a good life by being independent and accepted by society

FIG. 24 shows the results of the comparison in parenting attitudes. Here, “parenting attitudes” refer to guiding attitudes (i.e., whether the child is being raised in a way that is not overwhelming and is supportive of the child). As shown in FIG. 24, Type (A) is higher than the others, and Type (C) is lower than the others.

This indicates that the type of parent who wants to enhance their child's personal abilities will take a guiding attitude in dealing with their child, while the type who wants their child to just live well will not take such an attitude.

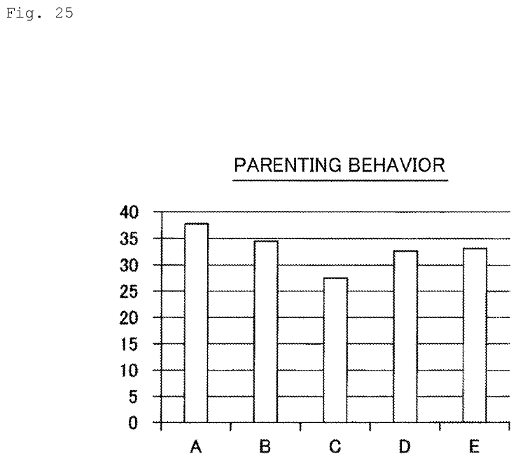

FIG. 25 shows the results of the comparison in parenting behaviors. Here, “parenting behavior” refers to whether the parents are doing things that provide various stimuli to their children. As shown in FIG. 25, Type (A) is higher than the others, and Type (C) is lower than the others.

This indicates that the type of parent who wants to enhance their children's personal abilities will try to give their child extensive stimulation, while the type who wants their child to just live well will not act in such a stimulating way.

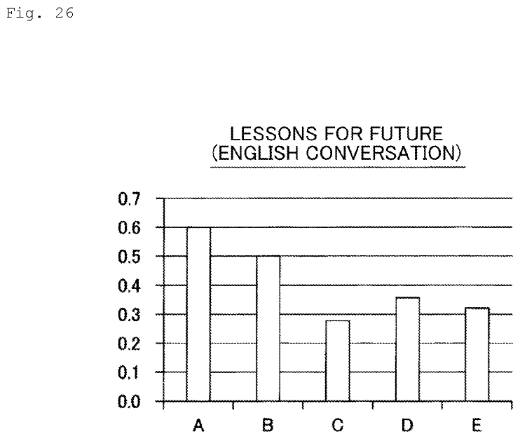

FIG. 26 shows the results of the comparison in the lessons (English conversation) to be given in the future. As shown in FIG. 26, Type (A) is higher than Types (C) and (E), and Types (C) and (E) are lower than Type (A), respectively.

This indicates that the type of parent who wants to enhance their children's personal abilities wants their children to learn English conversation in the future, compared to the type who wants their child to just live well and be accepted in society.

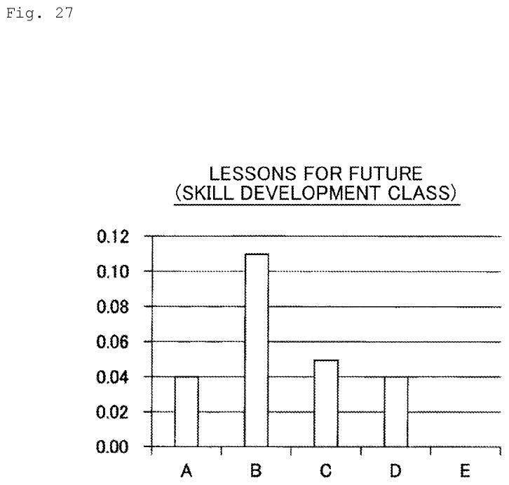

FIG. 27 shows the results of the comparison in the lessons (skill development class) to be given in the future. As shown in FIG. 27, Type (B) is higher than Type (E).

This indicates that the type of parent who values having a warm heart for others is more likely to want their child to attend a skill development class in the future (but less often).

<Summary of Experiment 1>

As mentioned above, in Experiment 1, mothers' long-term parenting goals (six factors) were extracted using a questionnaire, and were classified into parenting goal types (five types) according to the combinations of the factors. It was also confirmed that differences in parenting behavior arise depending on the parenting goal type.

<Discussion of Experiment 2>

The results of Experiment 2 showed that parenting goals related to behavior communicating affection were having a good parent-child relationship and showing warmth toward others. The former is thought to stem from the idea that showing behavior expressing affection, such as hugging a child, one can build a close relationship with the child, which will lead to a loving and trusting relationship in the future. In other words, it may be conceivable that building a good relationship through current expressions of affection is related to the future parent-child relationship.

The latter is thought to reflect the idea that it is important for parents to set an example and show love and compassion to their child in order for the child to become a person who is kind to others. In other words, this may reflect a parenting philosophy such as “parents showing love to their children produces children who are kind”.

Stimulating behavior was positively related to increased personal abilities and negatively related to good relationships with others. In other words, the idea is that extensive stimulation helps children develop their abilities. This is consistent with other cultures (e.g., Tudge et al., 2018). In the context of cultural comparison, “improving personal abilities” and “relationships with others” are similar to what are considered to be the different axes of autonomy-relatedness (Tamis-LeMonda et al., 2008), and may be related to the orientation of parenting behavior.

Disciplinary behavior was negatively related to increased personal abilities and positively related to warmth toward others and seriousness about life. It was suggested that “disciplinary behavior”, which trains a child to behave appropriately in society, is not considered appropriate for fostering a child's independence and the like, but it is considered necessary for parents to train their children to be disciplined in order for them to become a person who is warm toward others and serious.

Disciplinary behavior that raises children to be well-mannered is not consistent with parenting that aims to “improve individual abilities”. In other words, parenting behaviors which do not impose rules on children may be taken in order to “improve personal abilities”.

Although the foregoing has described the present embodiment, the present invention is not intended to be limited to this specific embodiment, and many variations and changes can be made without departing from the scope of the present invention as set forth in the scope of patent claims.

### REFERENCE SIGNS LIST

100, 200 Type estimation device
110 Survey presenting unit
120 Survey response input unit
130 Goal type estimation unit
140 Display unit
150 Recommendation unit
160 Information recommendation DB
300 List generation device
310 Survey response unit
320 Goal type estimation unit
330 Survey response writing unit
340 Response DB
350 DB generation instruction unit
360 Information recommendation DB generation unit
370 Information recommendation DB
1000 Drive device
1001 Recording medium
1002 Auxiliary storage device
1003 Memory device
1004 CPU
1005 Interface device
1006 Display device
1007 Input device

1. A type estimation device comprising a processor configured to execute a method comprising:
receiving as an input a response by a user to a predetermined question for estimating a parenting goal type of the user; and
estimating the parenting goal type of the user on the basis of the response,
wherein the predetermined question includes a question about what kind of person the user wants a child to become in the future or what kind of person the user does not want a child to become in the future.

2. The type estimation device according to claim 1, the processor further configured to execute a method comprising:
recommending a parenting behavior suited to the parenting goal type of the user on the basis of information indicating a relationship between parenting goal types and parenting behavior stored in an information recommendation database and the parenting goal type.

3. The type estimation device according to claim 2, the processor further configured to execute a method comprising:
generating information indicating a relationship between parenting goal types and parenting behavior on the basis of a first response that is a response by the user to the predetermined question for estimating the parenting goal type of the user and a second response that is a response regarding parenting behavior actually being performed by the user, and stores the information in an information recommendation database.

4. The type estimation device according to claim 3,
wherein the recommending further comprises recommending the parenting behavior suited to the parenting goal type of the user using the information recommendation database storing the information.

5. A type estimation method, the type estimation method comprising:
receiving as an input a response by a user to a predetermined question for estimating a parenting goal type of the user; and
estimating the parenting goal type of the user on the basis of the response,
wherein the predetermined question is a question about what kind of person the user wants a child to become in the future or what kind of person the user does not want a child to become in the future.

6. A computer-readable non-transitory recording medium storing computer-executable program instructions that when executed by a processor cause a computer to execute a method comprising:
receiving as an input a response by a user to a predetermined question for estimating a parenting goal type of the user; and
estimating the parenting goal type of the user on the basis of the response,
wherein the predetermined question is a question about what kind of person the user wants a child to become in the future or what kind of person the user does not want a child to become in the future.

7. The type estimation device according to claim 1, the processor further configured to execute a method comprising:
generating information indicating a relationship between parenting goal types and parenting behavior on the basis of a first response that is a response by the user to the predetermined question for estimating the parenting goal type of the user and a second response that is a response regarding parenting behavior actually being performed by the user, and stores the information in an information recommendation database.

8. The type estimation method according to claim 5, the type estimation method further comprising:
recommending a parenting behavior suited to the parenting goal type of the user on the basis of information indicating a relationship between parenting goal types and parenting behavior stored in an information recommendation database and the parenting goal type.

9. The type estimation method according to claim 5, the type estimation method further comprising:
generating information indicating a relationship between parenting goal types and parenting behavior on the basis of a first response that is a response by the user to the predetermined question for estimating the parenting goal type of the user and a second response that is a response regarding parenting behavior actually being performed by the user, and stores the information in an information recommendation database.

10. The type estimation method according to claim 8, the type estimation method further comprising:
generating information indicating a relationship between parenting goal types and parenting behavior on the basis of a first response that is a response by the user to the predetermined question for estimating the parenting goal type of the user and a second response that is a response regarding parenting behavior actually being performed by the user, and stores the information in an information recommendation database.

11. The type estimation method according to claim 10,
wherein the recommending further comprises recommending the parenting behavior suited to the parenting goal type of the user using the information recommendation database storing the information.

12. The computer-readable non-transitory recording medium according to claim 6, the computer-executable program instructions when execute further causing the computer to execute a method comprising:
recommending a parenting behavior suited to the parenting goal type of the user on the basis of information indicating a relationship between parenting goal types and parenting behavior stored in an information recommendation database and the parenting goal type.

13. The computer-readable non-transitory recording medium according to claim 6, the computer-executable program instructions when execute further causing the computer to execute a method comprising:
generating information indicating a relationship between parenting goal types and parenting behavior on the basis of a first response that is a response by the user to the predetermined question for estimating the parenting goal type of the user and a second response that is a response regarding parenting behavior actually being performed by the user, and stores the information in an information recommendation database.

14. The computer-readable non-transitory recording medium according to claim 12, the computer-executable program instructions when execute further causing the computer to execute a method comprising:
generating information indicating a relationship between parenting goal types and parenting behavior on the basis of a first response that is a response by the user to the predetermined question for estimating the parenting goal type of the user and a second response that is a response regarding parenting behavior actually being performed by the user, and stores the information in an information recommendation database.

15. The computer-readable non-transitory recording medium according to claim 14,
wherein the recommending further comprises recommending the parenting behavior suited to the parenting goal type of the user using the information recommendation database storing the information.
